(19) United States
(12) Patent Application Publication
(10) Pub. No.: US 2009/0069149 A1
(43) Pub. Date: Mar. 12, 2009

(54) BRAKE FORCE CONTROL DEVICE AND METHOD

(75) Inventors: Kazuya Okumura, Shizuoka-ken (JP); Kensuke Yoshizue, Shizuoka-ken (JP); Akihiro Hosokawa, Shizuoka-ken (JP); Yoshinori Maeda, Aichi-ken (JP); Naoki Moriguchi, Shizuoka-ken (JP); Kouji Sugiyama, Shizuoka-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JODOSHA KABUSHIKI KAISHA, AICHI-KEN (JP)

(21) Appl. No.: 12/298,953

(22) PCT Filed: Sep. 12, 2007
(86) PCT No.: PCT/IB2007/002610

§ 371 Date: Oct. 29, 2008

(30) Foreign Application Priority Data
Sep. 14, 2006 (JP) 2006-249881

(51) Int. Cl. H02P 3/04

(52) U.S. Cl. 477/28; 477/29

(57) ABSTRACT

A braking force control device includes: a brake control device that controls a mechanical brake braking torque by operating electric actuators so as to achieve a requested brake braking torque; a motor control device that controls a motor torque by operating motors so as to achieve the requested motor torque; a requested braking torque calculation device that calculates the requested braking torques of wheels; a battery requested electric power calculation device that finds a battery requested electric power based on target amounts of electricity charged in batteries; and an individual braking torque calculation device that finds the requested motor torque and the requested brake braking torque that cause the requested braking torque to be generated based on the battery requested electric power and the requested braking torque.

### BACKGROUND OF THE INVENTION

1. Field of the Invention

The invention relates to a braking force control device and a braking force control method of controlling the braking force that is generated on wheels.

2. Description of the Related Art

Conventionally, vehicles are equipped with a braking force generation device that generates braking force. In recent years, the braking force generation devices include not only hydraulic brake devices that transmit the oil pressure generated by a driver operating the brake pedal so as to generate hydraulic braking torque on wheels, but also include regenerative brake devices that generate, on wheels, regenerative braking torque from an electric motor, and electric brake devices that generate the electric brake braking torque on wheels by operating an electric actuator.

For example, Japanese Patent Application Publication No. 2004-155390 (JP-A-2004-155390) discloses a vehicle that brakes one of a front wheel and a rear wheel by a hydraulic brake device and that brakes the other one of the front wheel and the rear wheel through the use of an electric brake device and a regenerative brake device. In this vehicle, the regenerative electric power from the regenerative brake device is directly used as an operating power of the electric brake device without intervention of a battery. At that time, the battery is charged or discharged in accordance with the magnitude relationship between the consumed electric power of the electric brake device and the regenerative electric power from the regenerative brake device. For example, if the consumed electric power of the electric brake device is larger than the regenerative electric power from the regenerative brake device, the shortfall in power is supplied from the battery. If the consumed electric power of the electric brake device is smaller than the regenerative electric power from the regenerative brake device, the surplus is stored in the battery.

However, in Japanese Patent Application Publication No. 2004-155390 (JP-A-2004-155390), the regenerative braking torque and the electric brake braking torque are allowed to be generated without taking into account the capacity of the battery, and the charged electric power or the discharged electric power of the battery may become excessively large. Therefore, for example, if the battery reaches a state where the battery cannot be charged any more, the regenerative braking torque declines, and it becomes impossible to cause a requested amount of braking torque to be generated on the wheels. In such a case, the amount of decline in the regenerative braking torque needs to be compensated with an electric brake braking torque, and thus electric power from the battery is uselessly consumed, which is naturally undesirable.

### SUMMARY OF THE INVENTION

The invention provides a braking force control device and a braking force control method that are capable of generating requested braking torque while optimizing the amount of electricity stored in a battery.

In a first aspect of the invention, a braking force control device includes: a brake control device that controls a mechanical brake braking torque that is generated on a wheel by operating an electric actuator so as to achieve a brake braking torque requested (which is herein referred to as “requested brake braking torque”); a motor control device that controls a motor torque that is generated on the wheel by operating a motor so as to achieve the requested motor torque; a requested braking torque calculation device that calculates a requested braking torque of the wheel requested by a driver or a vehicle; a battery requested electric power calculation device that calculates a battery requested electric power based on a target amount of electricity charged in a battery mounted in the vehicle; and an individual braking torque calculation device that calculates the requested motor torque and the requested brake braking torque that cause the requested braking torque to be generated based on the requested braking torque and the battery requested electric power.

When the braking force control device of the foregoing aspect finds the requested brake braking torque and the requested motor torque that together cause the requested braking torque of the wheels to be generated, the braking force control device factors in not only the requested braking torque but also the battery requested electric power needed in order to maintain an optimal state of the amount of electricity stored in the battery. Therefore, in the braking force control device of the foregoing aspect, the battery requested electric power is equal to the difference between the consumed electric power due to the generation of the brake braking torque and the regenerative electric power due to the generation of the motor torque. Therefore, while an amount of electricity charged that corresponds to the battery requested electric power is secured, the requested braking torque is generated due to the brake braking torque and the motor torque.

In the braking force control device of the foregoing aspect, the individual braking torque calculation device may also be constructed so as to calculate the brake braking torque requested and the requested motor torque by further factoring in a consumed electric power of another electric appliance, such as an accessory or the like.

Then, by factoring in the consumed electric power of the electric appliances supplied with power from the battery, the foregoing braking force control device is able to maintain an even further optimal state of the amount of electricity stored in the battery.

The brake control device may be an electric brake control device that performs such a control that a mechanical electric brake braking torque generated directly by the electric actuator becomes equal to a requested electric brake braking torque and/or a hydraulic brake control device that performs such a control that a hydraulic brake braking torque generated via an oil pressure adjusted by the electric actuator becomes equal to a requested hydraulic brake braking torque.

A braking force control method in accordance with a second aspect of the invention is characterized by including: controlling a mechanical brake braking torque that is generated on a wheel by operating an electric actuator so as to achieve a brake braking torque requested; controlling a motor torque that is generated on the wheel by operating a motor so as to achieve the requested motor torque; calculating a requested braking torque of the wheel requested by a driver or a vehicle; calculating a battery requested electric power based on a target amount of electricity charged in a battery mounted in the vehicle; and calculating the requested motor torque and the requested brake braking torque that cause the requested braking torque to be generated based on the requested braking torque and the battery requested electric power.

Thus, the braking force control device in accordance with the foregoing aspects of the invention is able to generate the brake braking torque and the motor torque that satisfy the requested braking torque so that battery has a target amount of electricity stored. Therefore, according to this braking force control device, the requested braking torque on the wheel can be generated while an optimal state of the amount of electricity stored in the battery is maintained.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block diagram showing a construction of a braking force control device of Embodiment 1 in accordance with the invention;

FIG. 2 is a flowchart illustrating an operation of the braking force control device in Embodiment 1;

FIG. 3 is a block diagram showing a construction of a braking force control device of Embodiment 2 in accordance with the invention;

FIG. 4 is a flowchart illustrating an operation of the braking force control device in Embodiment 2;

FIG. 5 is a block diagram showing a construction of a braking force control device of Embodiment 3 in accordance with the invention; and

FIG. 6 is a flowchart illustrating an operation of the braking force control device in Embodiment 3.

### DETAILED DESCRIPTION OF THE EMBODIMENTS

Embodiments of the braking force control device in accordance with the invention will be described hereinafter with reference to the drawings. It is to be noted herein that the following embodiments do not limit the invention.

### Embodiment 1

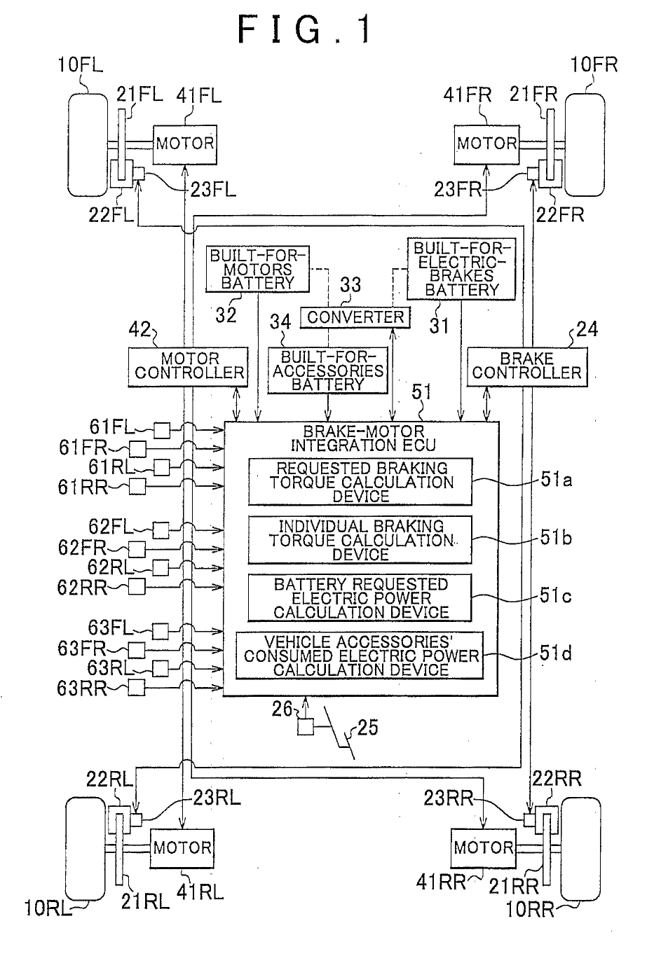

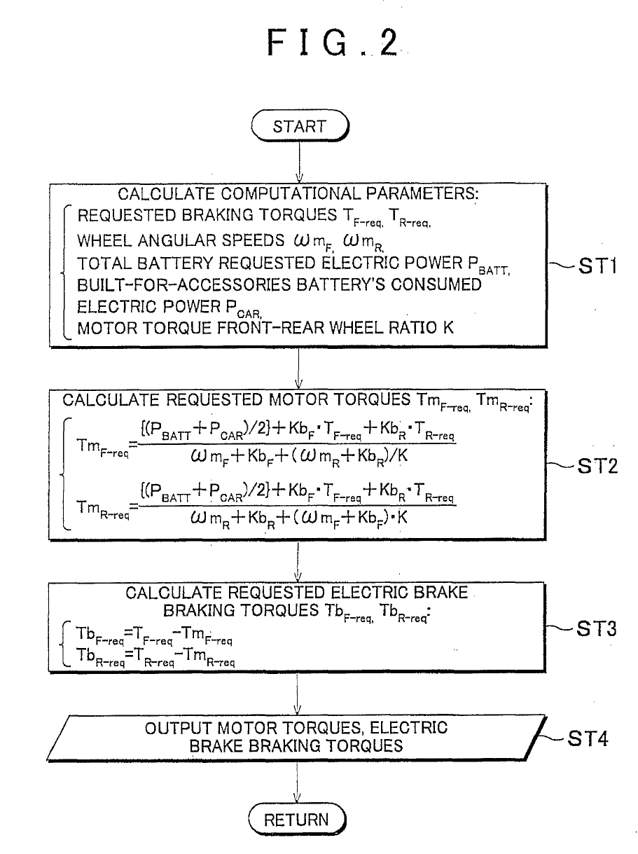

Embodiment 1 of the braking force control device in accordance with the invention will be described with reference to FIG. 1 and FIG. 2.

Firstly, a construction of a braking force control device in Embodiment I will be described with reference to FIG. 1. FIG. 1 shows a vehicle to which the braking force control device of Embodiment 1 is applied.

The vehicle in accordance with Embodiment 1 is provided with an electric brake device that generates braking torque individually for each of wheels 10FL, 10FR, 10RL, 10RR. For example, this electric brake device is an electrically-operated mechanical braking torque generation device that includes disc rotors 21FL, 21FR, 21RL, 21RR provided individually for the wheels 10FL, 10FR, 10RL, 10RR, respectively, calipers 22FL, 22FR, 22RL, 22RR equipped with brake pads (not shown) and pistons (not shown) that press the disc rotors 21FL, 21FR, 21RL, 21RR so as to generate mechanical brake braking torques Tb_{FL}, Tb_{FR}, Tb_{RL}, Tb_{RR}, respectively, and electric actuators 23FL, 23FR, 23RL, 23RR, such as motors or the like, that operate the pistons of the calipers 22FL, 22FR, 22RL, 22RR, respectively.

In Embodiment 1, a battery 31 dedicated to the electric brake device (hereinafter, referred to as “built-for-electric-brakes battery 31”) is provided. Although not shown, the built-for-electric-brakes battery 31 feeds the electric actuators 23FL, 23FR, 23RL, 23RR.

The electric brake device causes a brake controller 24 as an electric brake control device to control the operation of each of the electric actuators 23FL, 23FR, 23RL, 23RR, and thereby causes desired electric brake braking torques (hereinafter, referred to as “electric brake braking torques”) Tb_{FL}, Tb_{FR}, Tb_{RL}, Tb_{RR} to be generated on the individual wheels 10FL, 10FR, 10RL, 10RR. The brake controller 24 is a so-called electronic control device (ECU) constructed of a CPU (Central Processing Unit), a ROM (Read-Only Memory) in which predetermined control programs and the like are pre-stored, a RAM (Random Access Memory) for temporarily storing results of operations of the CPU, a backup RAM for storing information or the like prepared beforehand, etc. Herein, each electric brake braking torque Tb_{FL}, Tb_{FR}, Tb_{RL}, Tb_{RR} is defined as a positive value.

Furthermore, in the vehicle of Embodiment 1, the individual wheels 10FL, 10FR, 10RL, 10RR are provided with electric motors 41FL, 41FR, 41RL, 41RR, respectively, and a battery 32 dedicated to these motors (hereinafter, referred to as “built-for-motors battery 32”) is provided. Therefore, in Embodiment 1, the built-for-motors battery 32 feeds the individual motors 41FL, 41FR, 41RL, 41RR so as to generate motor power running torques, and also charges the built-for-motors battery 32 using the motor regenerative braking torques of the motors 41FL, 41FR, 41RL, 41RR. In Embodiment 1, although not shown, generators may be disposed between the motors 41FL, 41FR, 41RL, 41RR and the built-for-motors battery 32, or each of the motors 41FL, 41FR, 41RL, 41RR may also have a function of operating as a generator (i.e., a motor/generator) as well.

As the built-for-motors battery 32 of Embodiment 1, a battery that is higher in the operating voltage than the built-for-electric-brakes battery 31 is provided since the battery 32 needs to drive the motors 41FL, 41FR, 41RL, 41RR. In the vehicle of Embodiment 1, a generator (not shown) for charging the built-for-motors battery 32 is disposed, whereas a dedicated generator for charging the built-for-electric-brakes battery 31 that is a low-voltage battery is not disposed. Therefore, the vehicle of Embodiment 1 is provided with a converter (DC-DC converter) 33 that supplies voltage from the built-for-motors battery 32, to the built-for-electric-brakes battery 31 while converting the voltage.

The individual motors 41FL, 41FR, 41RL, 41RR are controlled by a motor controller 42 as a motor control device shown in FIG. 1 so as to apply desired motor torques Tm_{FL}, Tm_{FR}, Tm_{RL}, Tm_{RR} to the wheels 10FL, 10FR, 10RL, 10RR, respectively, The motor controller 42 is an electronic control device (ECU) constructed of a CPU (not shown) and the like, similarly to the above-described brake controller 24.

Each of the motor torques Tm_{FL}, Tm_{FR}, Tm_{RL}, Tm_{RR} is either a motor power running torque that causes a corresponding one of the wheels 10FL, 10FR, 10RL, 10RR to generate a drive force (hereinafter, referred to as “motor drive force”), or a motor regenerative braking torque that generates a regenerative braking force (hereinafter, referred to as “motor regenerative braking force”) from motion of a corresponding one of the wheels 10FL, 10FR, 10RL, 10RR. It is defined herein that each motor torque Tm_{FL}, Tm_{FR}, Tm_{RL}, Tm_{RR} represents a motor power running torque when it is a negative value, and represents a motor regenerative braking torque when it is a positive value.

Hence, when the motors 41FL, 41FR, 41RL, 41RR are caused to generate motor power running torques by the control of the motor controller 42, the corresponding wheels 10FL, 10FR, 10RL, 10RR receive motor drive forces in such directions as to move the wheels forward or rearward. For example, in the case where this vehicle is an electric motor vehicle, the motor power running torques of the motors 41FL, 41FR, 41RL, 41RR can be used as a motive power source of the vehicle. In the case where this vehicle is equipped also with a prime mover such as an internal combustion engine or the like, the motor power running torques of the motors 41FL, 41FR, 41RL, 41RR can be used as a motive power assist for the prime move or as a motive power source involved in the power switching with the prime mover.

On the other hand, when the motors 41FL, 41FR, 41RL, 41RR are caused to generate motor regenerative braking torques by the control of the motor controller 42, the corresponding wheels 10FL, 10FR, 10RL, 10RR receive motor regenerative braking forces in such directions as to brake the vehicle.

The vehicle of Embodiment 1 described above is able to cause both electric brake braking torque Tb_{FL}, Tb_{FR}, Tb_{RL}, Tb_{RR} and motor torque Tm_{FL}, Tm_{FR}, Tm_{RL}, Tm_{RR} to act on each of the wheels 10FL, 10FR, 10RL, 10RR. Therefore, on each of the wheels 10FL, 10FR, 10RL, 10RR, a magnitude of braking torque T_{FL}, T_{FR}, T_{RL}, T_{RR} that combines the electric brake braking torque Tb_{FL}, Tb_{FR}, Tb_{RL}, Tb_{RR} and the motor torque Tm_{FL}, Tm_{FR}, Tm_{RL}, Tm_{RR} occurs. For example, since motor torques Tm_{FL}, Tm_{FR}, Tm_{RL}, Tm_{RR} in different directions are generated depending on the control operation of the motor controller 42, each braking torque T_{FL}, T_{FR}, T_{RL}, T_{RR} can be provided by adding a motor torque Tm_{FL}, Tm_{FR}, Tm_{RL}, Tm_{RR} to or subtracting it from the electric brake braking torque Tb_{FL}, Tb_{FR}, Tb_{RL}, Tb_{RR}.

In this manner, in this vehicle, since the electric brake braking torques Tb_{FL}, Tb_{FR}, Tb_{RL}, Tb_{RR} and the motor torques Tm_{FL}, Tm_{FR}, Tm_{RL}, Tm_{RR} are individually increased or decreased for control, the magnitude of the braking torque T_{FL}, T_{FR}, T_{RL}, T_{RR} generated on the wheels 10FL, 10FR, 10RL, 10RR can be adjusted.

Therefore, the vehicle of Embodiment 1 is provided with an electronic control device (hereinafter, referred to as “brake-motor integration ECU”) 51 that calculates a braking torque that is desired to be generated on each of the wheels 10FL, 10FR, 10RL, 10RR (hereinafter, referred to as “requested braking torque”) T_{FL-req}, T_{FR-req}, T_{RL-req}, T_{RR-req}, and calculates a requested electric brake braking torque Tb_{FL-req}, Tb_{FR-req}, Tb_{RL-req}, Tb_{RR-req} and a requested motor torque Tm_{FL-req}, Tm_{FR-req}, Tm_{RL-req}, Tm_{RR-req} that satisfy each of the requested braking torques T_{FL-req}, T_{FR-req}, T_{RL-req}, T_{RR-req}, and outputs corresponding commands to the brake controller 24 and the motor controller 42. In Embodiment 1, the brake-motor integration ECU 51, the brake controller 24 and the motor controller 42 constitute a braking force control device of this vehicle.

Incidentally, in an ordinary vehicle, the braking torque of the front wheels 10FL, 10FR is set so as to be larger than that of the rear wheels 10RL, 10RR, taking the stability of the vehicle behavior at the time of braking into account. Technically speaking, in recent-year vehicles, the braking torques of the wheels 10FL, 10FR, 10RL, 10RR are able to be individually controlled in order to control the vehicle behavior not only at braking but also under other various situations in a fine control fashion in a direction to stability. In the brake-motor integration ECU 51 of Embodiment 1, too, the requested electric brake braking torque Tb_{FL-req}, Tb_{FR-req}, Tb_{RL-req}, Tb_{RR-req} and the requested motor torque Tm_{FL-req}, Tm_{FR-req}, Tm_{RL-req}, Tm_{RR-req} are calculated for each of the wheels 10FL, 10FR, 10RL, 10RR in order to make possible an individual control as described above.

In order to simplify the description, the following description will be made in conjunction with a representative example case in which braking torques T_{FL}, T_{FR} (=T_{F}) equal in magnitude are generated on the left and right front wheels 10FL, 10FR, and braking torques T_{RL}, T_{RR} (=T_{R}) equal in magnitude are also generated on the left and right rear wheels 10RL, 10RR. Furthermore, at that time, equal-magnitude electric brake braking torques Tb_{FL}, Tb_{FR} (=Tb_{F}) and equal-magnitude motor torques Tm_{FL}, Tm_{FR} (=Tm_{F}) are generated on the left and right front wheels 10FL, 10FR, and equal-magnitude electric brake braking torques Tb_{RL}, Tb_{RR} (=Tb_{R}) and equal-magnitude motor torques Tm_{RL}, Tm_{RR} (=Tm_{R}) are generated on the left and right rear wheels 10RL, 10RR.

Hence, the brake-motor integration ECU 51 in the following description roughly separates the front wheels 10FL, 10FR and the rear wheels 10RL, 10RR, and calculates a requested braking torque T_{F-req} of the front wheels 10FL, 10FR and a requested braking torque T_{R-req} of the rear wheels 10RL, 10RR. Furthermore, the brake-motor integration ECU 51 calculates a requested electric brake braking torque Tb_{F-req} and a requested motor torque Tm_{F-req} of the front wheels 10FL, 10FR as well as a requested electric brake braking torque Tb_{R-req} and a requested motor torque Tm_{R-req} of the rear wheels 10RL, 10RR so that the calculated torques satisfy the requested braking torques T_{F-req}) T_{R-req}.

Firstly, the brake-motor integration ECU 51 in Embodiment 1 is provided with a requested braking torque calculation device 51a that finds the requested braking torques T_{F-req}, T_{R-req} of the front wheels 10FL 10FR and the rear wheels 10RL, 10RR. For example, the requested braking torque calculation device 51a is constructed so as to calculate the requested braking torques T_{F-req}, T_{R-req} on the basis of the driver's brake operation (the amount of depression of a brake pedal 25, or the brake depression force). To this end, the vehicle of Embodiment 1 is provided with a brake operation amount detection device 26 that detects the amount of depression of the brake pedal 25 or the brake depression force thereon. For example, it is conceivable that the brake operation amount detection device 26 is formed by a brake depression force sensor, or a pedal position detection sensor that detects the position (amount of movement) of the brake pedal 25, or the like.

It is to be noted herein that the requested braking torque calculation device 51a may factor in not only the driver's brake operation but also the vehicle speed, the longitudinal acceleration, the transverse acceleration, etc. of the vehicle, in order to calculate the requested braking torques T_{F-req}, T_{R-req}. Therefore, high-accuracy requested braking torques T_{F-req}, T_{R-req} factoring in also the running state of the vehicle can be calculated. Hence, the requested braking torque calculation device 51a is constructed so as to calculate the requested braking torques T_{F-req}, T_{R-req} corresponding to a behavior control command and the like from not only the driver but also the vehicle (strictly speaking, the brake-motor integration ECU 51).

Furthermore, the brake-motor integration ECU 51 in Embodiment 1 is also provided with an individual braking torque calculation device 51b that calculates the requested electric brake braking torques Tb_{F-req}, Tb_{R-req} and the requested motor torques Tm_{F-req}, Tm_{R-req} that are needed in order to generate the requested braking torques T_{F-req}, T_{R-req}. The individual braking torque calculation device 51b in Embodiment 1 is constructed so as to calculate the requested electric brake braking torques Tb_{F-req}, Tb_{R-req} and the requested motor torques Tm_{F-req}, Tm_{R-req} that satisfy the requested braking torques T_{F-req}, T_{R-req}, in accordance with the state of a battery mounted in the vehicle (the built-for-electric-brakes battery 31 and the built-for-motors battery 32). Concretely, the individual braking torque calculation device 51b calculates the requested electric brake braking torques Tb_{F-req}, Tb_{R-req}, and the requested motor torques Tm_{F-req}, Tm_{R-req} that can satisfy the requested braking torques T_{F-req}, T_{R-req} while maintaining a predetermined amount of electricity stored in each of the built-for-electric-brakes battery 31 and the built-for-motors battery 32 without a shortfall nor an excess.

In order to retain such amounts of electricity stored, it is appropriate to find a target amount of electricity charged in each of the built-for-electric-brakes battery 31 and the built-for-motors battery 32 that satisfies the amount of electricity stored in the battery on the basis of the remaining capacity of the battery, and charge each of the built-for-electric-brakes battery 31 and the built-for-motors battery 32 with an electric power that corresponds to the target amount of electricity charged (hereinafter, referred to as “battery requested electric power”). That is, the battery requested electric power is an electric power that is needed in order to maintain an optimal state of the amount of electricity stored in each of the built-for-electric-brakes battery 31 and the built-for-motors battery 32. Then, in this case, the combined value of the battery requested electric powers of the built-for-electric-brakes battery 31 and the built-for-motors battery 32 that correspond to their respective target amounts of electricity charged is a battery requested electric power that is needed by the entire vehicle (hereinafter, referred to as “total battery requested electric power”) P_{BATT}.

Hence, the individual braking torque calculation device 51b in Embodiment 1 calculates the requested electric brake braking torques Tb_{F-req}, Tb_{R-req} and the requested motor torques Tm_{F-req}, Tm_{R-req} that satisfy the requested braking torques T_{F-req}, T_{R-req} while causing the total battery requested electric power P_{BATT} to be generated. Therefore, the brake-motor integration ECU 51 in Embodiment 1 is provided with a battery requested electric power calculation device 51c that calculates the total battery requested electric power P_{BATT} on the basis of the target amount of electricity charged (=a predetermined amount of electricity stored—the remaining capacity) of each of the built-for-electric-brakes battery 31 and the built-for-motors battery 32.

The electric power balance of the batteries (the built-for-electric-brakes battery 31, and the built-for-motors battery 32) in the entire vehicle can be represented by the following relational expression 1.

Expression 1

P_{BATT}=(Pm_{F}+Pm_{R}−Pb_{F}−Pb_{R})·2 (1)

In the expression 1, “Pm_{F}” represents the motor regenerative electric power per front wheel when the motors 41FL, 41FR of the front wheels 10FL, 10FR perform regenerative braking with the requested motor torque Tm_{F-req}. The value Pm_{F} can be represented by the following expression 2 using the wheel angular speed ωm_{F} of the front wheels 10FL, 10FR and the requested motor torque Tm_{F-req} of the front wheels 10FL, 10FR. Besides, “Pm_{R}” in the expression 1 represents the motor regenerative electric power per rear wheel when the motors 41RL, 41RR of the rear wheels 10RL, 10RR perform regenerative braking with the requested motor torque Tm_{R-req}. The value Pm_{R} can be represented by the following expression 3 using the wheel angular speed ωm_{R} of the rear wheels 10RL, 10RR and the requested motor torque Tm_{R-req} of the rear wheels 10RL, 10RR. The motor regenerative electric powers Pm_{F}, Pm_{R} are each defined as a positive value.

Expression 2

Pm_{F}=ωm_{F}·Tm_{F-req} (2)

Expression 3

Pm_{R}=ωm_{R}·Tm_{R-req} (3)

For example, in Embodiment 1, axle shafts or the like of the front wheels 10FL, 10FR are provided with wheel speed sensors 61FL, 61FR shown in FIG. 1, and the brake-motor integration ECU 51 is caused to find the wheel angular speed ωm_{F} of the front wheels 10FL, 10FR on the basis of a detection of each of these wheel speed sensors (wheel rotation speed). Likewise, in Embodiment 1, axle shafts or the like of the rear wheels 10RL, 10RR are provided with wheel speed sensors 61RL, 61RR shown in FIG. 1, and the brake-motor integration ECU 51 is caused to find the wheel angular speed ωm_{R} of the rear wheels 10RL, 10RR on the basis of a detection signal of each of these wheel speed sensors.

Furthermore, “Pb_{F}” in the expression 1 represents the electric power per front wheel that is needed in order to generate a requested electric brake braking torque Tb_{F-req} on the front wheels 10FL, 10FR (hereinafter, referred to as “electric brakes' consumed electric power”), and can be represented by the following expression 4 using an electric brake braking torque/electric power conversion coefficient Kb_{F} of the front wheels 10FL, 10FR, and the requested electric brake braking torque Tb_{F-req} of the front wheels 10FL, 10FR. Besides, “Pb_{R}” in the expression 1 represents the electric brakes' consumed electric power per rear wheel that is needed in order to generate a requested electric brake braking torque Tb_{R-req} on the rear wheels 10RL, 10RR, and can be expressed by the following expression 5 using an electric brake braking torque/electric power conversion coefficient Kb_{R} of the rear wheels 10RL, 10RR, and the requested electric brake braking torque Tb_{R-req} of the rear wheels 10RL, 10RR. The electric brake braking torque/electric power conversion coefficient Kb_{F} (Kb_{R}) is a characteristic value dependent on the electric brake system that represents a relationship between the electric brake braking torque Tb_{F} (Tb_{R}) and the magnitude of electric power needed for generating the electric brake braking torque Tb_{F} (Tb_{R}), and shows a necessary electric power per unit torque. In this example, each of the electric brakes' consumed electric powers Pb_{F}, Pb_{R} is defined as a positive value.

Expression 4

Pb_{F}=Kb_{F}·Tb_{F-req} (4)

Expression 5

Pb_{R}=Kb_{R}·Tb_{R-req} (5)

In Embodiment 1, the expressions 2 to 5 are substituted in the expression 1, and then braking torque relational expressions regarding the front wheels 10FL, 10FR and regarding the rear wheels 10RL, 10RR shown below as expressions 6 and 7 and a motor torque front-rear wheel ratio K shown in the following expression 8 are used to derive a computational expression for the requested motor torque Tm_{F-req} of the front wheels 10FL, 10FR and a computational expression for the requested motor torque Tm_{R-req} of the rear wheels 10RL, 10RR shown below as expressions 9 and 10.

Expression 6

T_{F-req}=Tb_{F-req}+Tm_{F-req} (6)

Expression 7

T_{R-req}=Tb_{R-req}+Tm_{R-req} (7)

Expression 8

K=Tm_{F-req}/Tm_{R-req} (6)

The motor torque front-rear wheel ratio K represents the ratio between the requested motor torque Tm_{F-req} of the front wheels 10FL, 10FR and the requested motor torque Tm_{R-req} of the rear wheels 10RL, 10RR, and is a value that has been set so as to make appropriate the amount of electricity charged into the built-for-motors battery 32. This motor torque front-rear wheel ratio K is determined on the basis of the temperatures of the disc rotors 21FL, 21FR, 21RL, 21RR (or of the brake pads in the calipers 22FL, 22FR, 22RL, 22RR) and the temperatures of the motors 41FL, 41FR, 41RL, 41RR.

For example, in the case where the disc rotors 21FL, 21FR of the front wheels 10FL, 10FR are in a high temperature state, further increasing of the electric brake braking torque Tb_{F} of the front wheels 10FL, 10FR may cause a fade between the disc rotors 21FL, 21FR and the brake pads, and is therefore not preferable. Therefore, in such a case, the electric brake braking torque Tb_{F} of the front wheels 10FL, 10FR can be reduced merely by correspondingly increasing the requested motor torque Tm_{F-req} of the front wheels 10FL, 10FR to the regenerative braking side. However, simple performance of this operation may, for example, excessively increase the amount of electricity charged into the built-for-motors battery 32 by the regenerative braking, giving rise to a possibility of decline in the motor torques Tm_{F}, Tm_{R} of the front wheels 10FL, 10FR and the rear wheels 10RL, 10RR. In such a case, this can be avoided merely by setting the motor torque front-rear wheel ratio K so that the requested motor torque Tm_{R-req} of the rear wheels 10RL, 10RR becomes smaller by the amount of the increase of the requested motor torque Tm_{F-req} of the front wheels 10FL, 10FR. Therefore, in Embodiment 1, the amount of electricity charged into the built-for-motors battery 32 can be made proper by taking the motor torque front-rear wheel ratio K into account.

The temperatures of the disc rotors 21FL, 21FR, 21RL, 21RR (or of the brake pads in the calipers 22FL, 22FR, 22RL, 22RR) may be detected, for example, by providing these with temperature sensors 62FL, 62FR, 62RL, 62RR, or may also be estimated from the frequency of use of the electric brake or the electric brake braking torques Tb_{F}, Tb_{R}. Furthermore, the temperatures of the motors 41FL, 41FR, 41RL, 41RR may be detected, for example, by providing these motors with temperature sensors 63FL, 63FR, 63RL, 63RR, or may also be estimated from the frequency of use of the motors 41FL, 41FR, 41RL, 41RR or the motor torques Tm_{F}, Tm_{R}.

$$\begin{matrix}Expression 9 & \\ {Tm}_{F - req} = \frac{( {P}_{BATT} \text{/} 2 ) + {Kb}_{F} \cdot {T}_{F - req} + {Kb}_{R} \cdot {T}_{R - req}}{ω {m}_{F} + {Kb}_{F} + ( ω {m}_{R} + {Kb}_{R} ) \text{/} K} & ( 9 ) \\ Expression 10 & \\ {Tm}_{R - req} = \frac{( {P}_{BATT} \text{/} 2 ) + {Kb}_{F} \cdot {T}_{F - req} + {Kb}_{R} \cdot {T}_{R - req}}{ω {m}_{R} + {Kb}_{R} + ( ω {m}_{F} + {Kb}_{F} ) \cdot K} & ( 10 )\end{matrix}$$

The individual braking torque calculation device 51b in Embodiment 1 calculates the requested motor torque Tm_{F-req} of the front wheels 10FL, 10FR and the requested motor torque Tm_{R-req} of the rear wheels 10RL, 10RR, using the expressions 9 and 10, Then, the individual braking torque calculation device 51b calculates the requested electric brake braking torque Tb_{F-req} of the front wheels 10FL, 10FR using the following expression modified from the expression 6, and calculates the requested electric brake braking torque Tb_{R-req} of the rear wheels 10RL, 10RR using the following expression 12 modified from the expression 7.

Expression 11

Tb_{F-req}=T_{F-req}−Tm_{F-req} (11)

Expression 12

Tb_{R-req}=T_{R-req}−Tm_{R-req} (12)

Thus, through the use of the expressions 9 to 12, the requested electric brake braking torques Tb_{F-req}, Tb_{R-req} and the requested motor torques Tm_{F-req}, Tm_{R-req} which cause the generation, by regenerative braking force, of the total battery requested electric power P_{BATT} that can maintain proper amounts of electricity stored in the built-for-electric-brakes battery 31 and the built-for-motors battery 32 and which are able to satisfy the requested braking torque T_{F-req}, T_{R-req} are calculated.

Therefore, since a difference between the consumed electric power of the built-for-electric-brakes battery 31 involved in the generation of the electric brake braking torques Tb_{F}, Tb_{R} and the regenerative electric power stored into the built-for-motors battery 32 due to the generation of the motor torques Tm_{F}, Tm_{R} is equal to the total battery requested electric power P_{BATT}, it is possible to generate the requested braking torques T_{F-req}, T_{R-req} due to the electric brake braking torques Tb_{F}, Tb_{R} and the motor torques Tm_{F}, Tm_{R} while securing an amount of electricity charged, into the built-for-electric-brakes battery 31 and the built-for-motors battery 32 in accordance with the total battery requested electric power P_{BATT}. Hence, in Embodiment 1, it is possible to generate, on the front wheels 10FL, 10FR and the rear wheels 10RL, 10RR, the requested braking torques T_{F-req}, T_{R-req} requested by the driver or the vehicle while maintaining proper amounts of electricity stored in both the built-for-electric-brakes battery 31 and the built-for-motors battery 32. Then, this allows the vehicle to obtain a necessary vehicle deceleration.

As a result of this, it is possible to prevent a decline in the electric brake braking torques Tb_{F}, Tb_{R} caused by insufficient amount of electricity stored in the built-for-electric-brakes battery 31. Besides, it is also possible to prevent a decline in the motor torques Tm_{F}, Tm_{R} caused by the electric power charged at the time of excessive regeneration of the built-for-motors battery 32. Since this makes it unnecessary to compensate the decline in the motor torques Tm_{F}, Tm_{R} with the electric brake braking torques Tb_{F}, Tb_{R}, it is possible to avoid waste of electric power of the built-for-electric-brakes battery 31. Therefore, in Embodiment 1, for example, it is possible to avoid increase of the load of the motor torques Tm_{F}, Tm_{R} (the electric brake braking torques Tb_{F}, Tb_{R}) on the wheels.

In some vehicles, electric power for other electric appliances, such as accessories and the like, is supplied from an existing battery (e.g., the built-for-electric-brakes battery 31 or the built-for-motors battery 32), while in some other vehicles, such electric power is supplied from a battery dedicated to those electric appliances (hereinafter, referred to as “built-for-electric-appliances battery”). For example, in the vehicle of Embodiment 1, as shown in FIG. 1, a built-for-accessories battery 34 is provided as a built-for-electric-appliances battery, and a dedicated generator for charging the built-for-accessories battery 34, which is a low-voltage battery, is not provided. Therefore, in such a case, voltage from the built-for-motors battery 32 is converted and supplied to the built-for-accessories battery 34 via a converter 33, similarly to the built-for-electric-brakes battery 31. Therefore, the amount of electricity stored in the batteries in the entire vehicle (the built-for-electric-brakes battery 31, the built-for-motors battery 32 and the built-for-accessories, battery 34) cannot be kept in an optimal state unless the consumed electric power from the built-for-accessories battery 34 is taken into account.

Hence, in this case, the total battery requested electric power P_{BATT} is obtained by adding a battery request power that corresponds to the target amount of electricity charged in the built-for-accessories battery 34, and is found by the battery requested electric power calculation device 51c.

The electric power balance between the batteries in the entire vehicle (the built-for-electric-brakes battery 31, the built-for-motors battery 32 and the built-for-accessories battery 34) is represented by the following relational expression 13.

Expression 13

P_{BATT}=(Pm_{F}+Pm_{R}−Pb_{F}−Pb_{R})·2−P_{CAR} (13)

In the expression 13, “P_{CAR}” represents the consumed electric power of the built-for-accessories battery 34 (=the target amount of electricity charged therein). The brake-motor integration ECU 51 in Embodiment 1 is provided with a vehicle accessories' consumed electric power calculation device 51d that calculates the built-for-accessories battery's consumed electric power P_{CAR} on the basis of the target amount of electricity charged (=a predetermined amount of electricity stored−the remaining capacity).

Therefore, in the case cohere the built-for-accessories battery 34 as described above is provided, a computational expression for the requested motor torque Tm_{F-req} of the front wheels 10FL, 10FR and a computational expression for the requested motor torque Tm_{R-req} of the rear wheels 10RL, 10RR shown below as the expressions 14 and 15 are derived similarly to the expressions 9 and 15.

$$\begin{matrix}Expression 14 & \\ {Tm}_{F - req} = \frac{\{ ( {P}_{BATT} + {P}_{CAR} ) \text{/} 2 \} + {Kb}_{F} \cdot {T}_{F - req} + {Kb}_{R} \cdot {T}_{R - req}}{ω {m}_{F} + {Kb}_{F} + ( ω {m}_{R} + {Kb}_{R} ) \text{/} K} & ( 14 ) \\ Expression 15 & \\ {Tm}_{R - req} = \frac{\{ ( {P}_{BATT} + {P}_{CAR} ) \text{/} 2 \} + {Kb}_{F} \cdot {T}_{F - req} + {Kb}_{R} \cdot {T}_{R - req}}{ω {m}_{R} + {Kb}_{R} + ( ω {m}_{F} + {Kb}_{F} ) \cdot K} & ( 15 )\end{matrix}$$

In this case, the individual braking torque calculation device 51b calculates the requested electric brake braking torques Tb_{F-req}, Tb_{R-req} using the expressions 14 and 15, and calculates the requested motor torques Tm_{F-req}, Tm_{R-req} using the expressions 11 and 12.

A computational processing operation of a braking force control device provided with the individual braking torque calculation device 51b will be described hereinafter with reference to the flowchart of FIG. 2.

Firstly, the brake-motor integration ECU 51 finds computational parameters for calculating the requested electric brake braking torques Tb_{F-req}, Tb_{R-req} and the requested motor torques Tm_{F-req}, Tm_{R-req} (step ST1). In this step, the brake-motor integration ECU 51 calculates the requested braking torque T_{F-req} of the front wheels 10FL, 10FR, the requested braking torque T_{R-req} of the rear wheels 10RL, 10RR, the wheel angular speed ωm_{F} of the front wheels 10FL, 10FR, the wheel angular speed ωm_{R} of the rear wheels 10RL, 10RR, the total battery requested electric power P_{BATT}, the built-for-accessories battery's consumed electric power P_{CAR}, and the motor torque front-rear wheel ratio K.

Firstly, the brake-motor integration ECU 51, using the requested braking torque calculation device 51a, calculates the requested braking torque T_{F-req} of the front wheels 10FL, 10FR and the requested braking torque T_{R-req} of the rear wheels 10RL, 10RR on the basis of the driver's depression amount of the brake pedal 25 and the driver's, brake depression force detected via the brake operation amount detection device 26, the vehicle speed, the vehicle longitudinal acceleration, and the vehicle lateral acceleration.

For example, the requested braking torques T_{F-req}, T_{R-req} are torques that can generate an appropriate braking force while maintaining a stable vehicle behavior. In Embodiment 1, map data that allows such requested braking torques T_{F-req}, T_{R-req} to be derived through the use of the aforementioned depression amount, the brake depression force, etc., as parameters, is prepared beforehand. Although not shown, the vehicle of Embodiment 1 is equipped with a vehicle speed sensor, a longitudinal acceleration sensor, and a lateral acceleration sensor.

Furthermore, the brake-motor integration ECU 51 takes up detection signals from the wheel speed sensors 61FL, 61FR, 61RL, 61RR of the wheels 10FL, 10FR, 10RL, 10RR, and calculates the wheel angular speed ωm_{F} of the front wheels 10FL, 10FR and the wheel angular speed ωm_{R} of the rear wheels 10RL, 10RR on the basis of these detection signals.

Furthermore, the brake-motor integration ECU 51 finds the total battery requested electric power P_{BATT}, using the battery requested electric power calculation device 51c. At that time, on the basis of the remaining capacity of the built-for-electric-brakes battery 31 that is received from the built-for-electric-brakes battery 31, and a predetermined amount of electricity stored in the built-for-electric-brakes battery 31, the battery requested electric power calculation device 51c calculates a target amount of electricity charged in the built-for-electric-brakes battery 31 (=the predetermined amount of electricity stored—the remaining capacity). Then, the battery requested electric calculation device 51c finds a battery requested electric power of the built-for-electric-brakes battery 31 that corresponds to the target amount of electricity charged. Likewise, the battery requested electric power calculation device 51c also calculates a target amount of electricity charged in the built-for-motors battery 32 (=a predetermined amount of electricity stored—the remaining capacity) upon receiving information regarding the remaining capacity of the built-for-motors battery 32 from the built-for-motors battery 32. Then, the battery requested electric power calculation device 51c finds a battery requested electric power of the built-for-motors battery 32 that corresponds to the target amount of electricity charged. Furthermore, the battery requested electric power calculation device 51c calculates a target amount of electricity charged in the built-for-accessories battery 34 (=a predetermined amount of electricity stored—the remaining capacity) on the basis of information regarding the remaining capacity of the built-for-accessories battery 34 that is received from the built-for-accessories battery 34. Then, the battery requested electric power calculation device 51c finds a battery requested electric power of the built-for-accessories battery 34 that corresponds to the target amount of electricity charged. After that, the battery requested electric power calculation device 51c sums the battery requested electric powers of the built-for-electric-brakes battery 31, the built-for-motors battery 32 and the built-for-accessories battery 34, and determines it as a total battery requested electric power P_{BATT}.

The brake-motor integration ECU 51 also finds a built-for-accessories battery's consumed electric power P_{CAR}, using the vehicle accessories' consumed electric power calculation device 51d. At that time, the vehicle accessories' consumed electric power calculation device 51d calculates an electric power that corresponds to the target amount of electricity charged in the built-for-accessories battery 34, as a built-for-accessories battery's consumed electric power P_{CAR}. Incidentally, the built-for-accessories battery's consumed electric power P_{CAR} is equal to the battery requested electric power of the built-for-accessories battery 34 that the battery requested electric power calculation device 51c uses to find the total battery requested electric power P_{BATT}. Therefore, either the battery requested electric power of the built-for-accessories battery 34 or the built-for-accessories battery's consumed electric power P_{CAR} found by a corresponding one of the battery requested electric power calculation device 51c and the vehicle accessories' consumed electric power calculation device 51d may be used for the calculation of the other one of those electric powers.

Then, finally, the brake-motor integration ECU 51 detects the temperatures of the disc rotors 21FL, 21 FR, 21RL, 21RR (or of the brake pads in the calipers 22FL, 22FR, 22RL, 22RR) from the detection signals from the temperature sensors 62FL, 62FR, 62RL, 62RR, respectively, and also calculates the temperatures of the motors 41FL, 41FR, 41RL, 41RR from the detection signals from the temperature sensors 63FL, 63FR, 63RL, 63RR, respectively, and then calculates the motor torque front-rear wheel ratio K on the basis of these temperatures. For example, in Embodiment 1, map data that makes it possible to deprive the motor torque front-rear wheel ratio K that can make appropriate the amount of electricity charged into the built-for-motors battery 32 through the use of the aforementioned temperatures as parameters is prepared beforehand.

The brake-motor integration ECU 51 in Embodiment 1, using the individual braking torque calculation device 51b, substitutes the various computational parameters found as described above in the foregoing expressions 14 and 15 to calculate the requested motor torque Tm_{F-req} of the front wheels 10FL, 10FR and the requested motor torque Tm_{R-req} of the rear wheels 10RL, 10RR (step ST2).

Then, the individual braking torque calculation device 51b calculates the requested electric brake braking torque Tb_{F-req} of the front wheels 10FL, 10FR and the requested electric brake braking torque Tb_{R-req} of the rear wheels 10RL, 10RR (step ST3). At that time, the individual braking torque calculation device 51b finds the requested electric brake braking torque Tb_{F-req} regarding the front wheels 10FL, 10FR by substituting the requested motor torque Tm_{F-req} of the front wheels 10RL, 10FR and the requested braking torque T_{F-req} of the front wheels 10FL, 10FR found in step ST1 in the expression 11. Likewise, the individual braking torque calculation device 51b finds the requested electric brake braking torque Tb_{R-req} regarding the rear wheels 10RL, 10RR by substituting the requested motor torque Tm_{R-req} of the rear wheels 10RL, 10RR and the requested braking torque T_{R-req} of the rear wheels 10RL, 10RR found in step ST1 in the expression 12.

After that, the brake-motor integration ECU 51 in Embodiment 1 sends commands to the motor controller 42 and to the brake controller 24 to cause the requested motor torques Tm_{F-req}, Tm_{R-req} and the requested electric brake braking torques Tb_{F-req}, Tb_{R-req} found in steps ST2 and ST3 to be generated on the corresponding wheels 10FL, 10FR, 10RL, 10RR (step ST4).

Therefore, the balance among the consumed electric power of the built-for-electric-brakes battery 31 caused by the generation of the electric brake braking torques Tb_{F}, Tb_{R}, the regenerative electric power to the built-for-motors battery 32 due to the generation of the motor torques Tm_{F}, Tm_{R}, and the consumed electric power of the built-for-accessories battery 34 caused by the use of accessories is equal to the total battery requested electric power P_{BATT}. Therefore, while amounts of electricity charged in all the batteries of the vehicle (the built-for-electric-brakes battery 31, the built-for-motors battery 32 and the built-for-accessories battery 34) in accordance with the total battery requested electric power P_{BATT} are secured, the requested braking torques T_{F-req}, T_{R-req} can be generated by the electric brake braking torques Tb_{F}, Tb_{R} and the motor torques Tm_{F}, Tm_{R}. Hence, in Embodiment 1, while proper amounts of electricity stored in all the batteries of the vehicle are maintained, the requested braking torques T_{F-req}, T_{R-req} requested by the driver or the vehicle can be generated on the front wheels 10FL, 10FR and the rear wheels 10RL, 10RR. Therefore, this vehicle can obtain a necessary vehicle deceleration. Furthermore, since the consumed electric power from the built-for-accessories battery 34 is also taken into account, the amounts of electricity stored in all the batteries of the vehicle can be kept optimal.

Therefore, in the case where the built-for-accessories battery 34 is provided, a decline in the electric brake braking torques Tb_{F}, Tb_{R} or the motor torques Tm_{F}, Tm_{R} caused by imbalanced charging/discharging can be prevented as in the case where the built-for-accessories battery 34 is not provided, and therefore substantially the same effects as in that case can be achieved.

### Embodiment 2

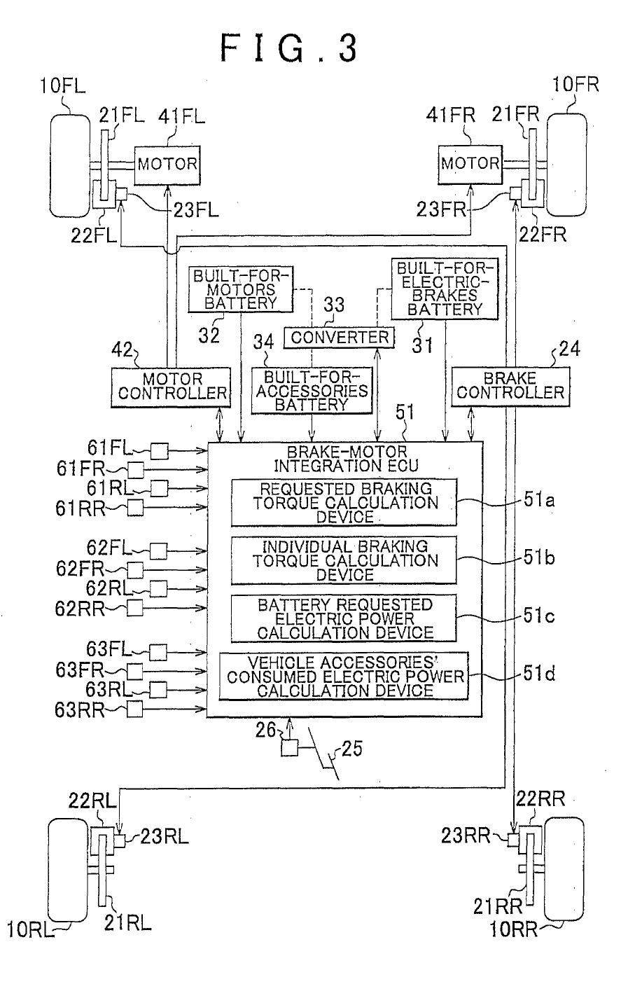

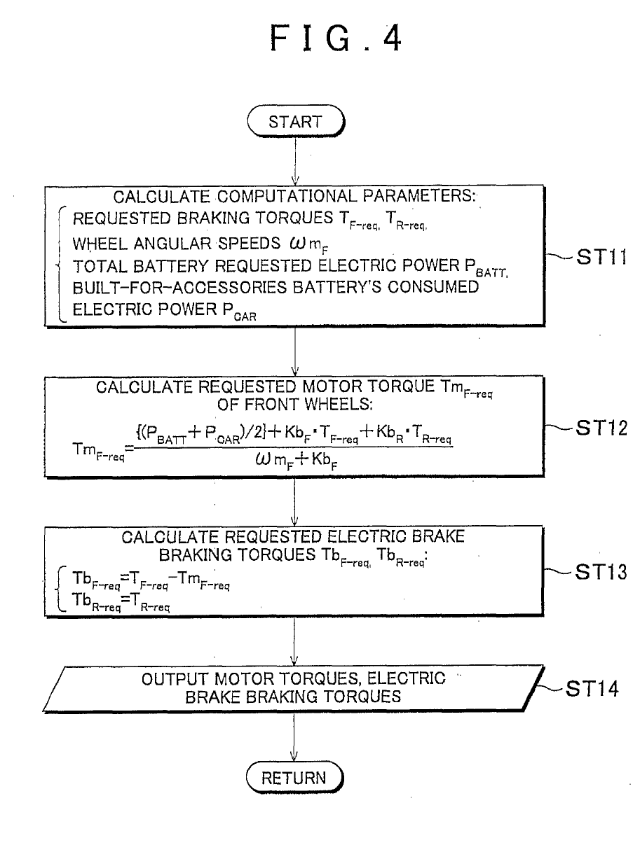

Next, Embodiment 2 of the braking force control device in accordance with the invention will be described with reference to FIGS. 3 and 4.

Embodiment 2 is about a braking force control device applicable to a vehicle as shown in FIG. 3 that is obtained by removing the motors 41RL, 41RR of the rear wheels 10RL, 10RR from the foregoing vehicle of Embodiment 1. In the description below, the vehicle of Embodiment 2 is equipped with a built-for-accessories battery 34.

The braking force control device of Embodiment 2, as in Embodiment 1, is constructed of a brake-motor integration ECU 51, a brake controller 24, and a motor controller 42, and is different from the braking force device of Embodiment 1 in that the rear wheels 10RL, 10RR are not provided with motors 41RL, 41RR. Hereinafter, a computational processing operation of the braking force control device will be described with reference to the flowchart of FIG. 4, and differences thereof from the computational process operation in Embodiment I will be described.

Firstly, the brake-motor integration ECU 51 of Embodiment 2 finds computational parameters for calculating the requested electric brake braking torques Tb_{F-req}, Tb_{R-req} and the requested motor torque Tm_{F-req} (step ST11). In Embodiment 2, the brake-motor integration ECU 51 calculates the requested braking torque T_{F-req} of the front wheels 10FL, 10FR, the requested braking torque T_{R-req} of the rear wheels 10RL, 10RR, the wheel angular speed ωm_{F} of the front wheels 10FL, 10FR, the total battery requested electric power P_{BATT} and the built-for-accessories battery's consumed electric power P_{CAR} in the same manner as in Embodiment 1. However, in Embodiment 2, the brake-motor integration ECU 51 does not calculate the wheel angular speed ωm_{R} of the rear wheels 10RL, 10RR or the motor torque front-rear wheel ratio K since neither the requested motor torque T_{R-req} of the rear wheels 10RL, 10RR nor the motor regenerative electric power Pm_{R} occurs.

Subsequently, the brake-motor integration ECU 51, using the individual braking torque calculation device 51b, calculates the requested motor torque Tm_{F-req} of the front wheels 10FL, 10FR by substituting various computational parameters in the following expression 16 (step ST12).

$$\begin{matrix}Expression 16 & \\ {Tm}_{F - req} = \frac{\{ ( {P}_{BATT} + {P}_{CAR} ) \text{/} 2 \} + {Kb}_{F} \cdot {T}_{F - req} + {Kb}_{R} \cdot {T}_{R - req}}{ω {m}_{F} + {Kb}_{F}} & ( 16 )\end{matrix}$$

The computational expression for the requested motor torque Tm_{F-req} of the front wheels 10FL, 10FR shown as the expression 16 is derived as in Example 1, on the basis of a relational expression shown as the expression 17 that concerns the electric power balance of the batteries (the built-for-electric-brakes battery 31, the built-for-motors battery 32 and the built-for-accessories battery 34) in the entire vehicle.

Expression 17

P_{BATT}=(Pm_{F}−Pb_{F}−Pb_{R})·2−P_{CAR} (17)

Then, the individual braking torque calculation device 51b calculates the requested electric brake braking torque Tb_{F-req} of the front wheels 10FL, 10FR and the requested electric brake braking torque Tb_{R-req} of the rear wheels 10RL, 10RR (step ST13). The individual braking torque calculation device 51b finds the requested electric brake braking torque Tb_{F-req} regarding the front wheels 10FL, 10FR by substituting the requested braking torque T_{F-req} of the front wheels 10FL, 10FR found in step ST11 and the requested motor torque Tm_{F-req} of the front wheels 10FL, 10FR in the expression 11 as in Embodiment 1. However, in Embodiment 2, the requested braking torque T_{R-req} of the rear wheels 10RL, 10RR found in step ST11 is directly set as the requested electric brake braking torque Tb_{R-req} of the rear wheels 10RL, 10RR.

After that, the brake-motor integration ECU 51 in Embodiment 2 sends commands to the motor controller 42 and the brake controller 24 to cause the requested motor torque Tm_{F-req} and the requested electric brake braking torques Tb_{F-req}, Tb_{R-req} found in the steps ST12 and ST13 to be generated on the corresponding wheels 10FL, 10FR, 10RL, 10RR (step ST14).

In this manner, too, the braking force control device of Embodiment 2, similarly to the device of Embodiment 1, is able to generate the requested braking torques T_{F-req}, T_{R-req} requested by the driver or the vehicle on the front wheels 10FL, 10FR and the rear wheels 10RL, 10RR while maintaining proper amounts of electricity stored in all the batteries (the built-for-electric-brakes battery 31, the built-for-motors battery 32 and the built-for-accessories battery 34) mounted in the vehicle. Hence, in the vehicle of Embodiment 2, too, necessary vehicle deceleration can be obtained.

Therefore, Embodiment 2, similarly to Embodiment 1, is able to prevent declines in the electric brake braking torques Tb_{F}, Tb_{R} and the motor torque Tm_{F} associated with imbalanced charging/discharging, and is able to achieve substantially the same effects as Embodiment 1.

It is to be noted herein that although, in the foregoing description, Embodiment 2 is applied to a vehicle obtained by removing the motors 41RL, 41RR of the rear wheels 10RL, 10RR from the vehicle of Embodiment 1, a braking force control device in accordance with the invention may also be applied to a vehicle obtained by removing the motors 41FL, 41FR of the front wheels 10FL, 10FR from the vehicle of Embodiment 1, and this application achieves substantially the same effects as mentioned above.

In this case, a computational expression for the requested motor torque Tm_{R-req} of the rear wheels 10RL, 10RR shown below as an expression 19 is derived on the basis of a relational expression shown below as an expression 18 which concerns the electric power balance of the batteries (the built-for-electric-brakes battery 31, the built-for-motors battery 32 and the built-for-accessories battery 34) of the entire vehicle.

$$\begin{matrix}Expression 18 & \\ {P}_{BATT} = ( {Pm}_{R} - {Pb}_{F} - {Pb}_{R} ) \cdot 2 - {P}_{CAR} & ( 18 ) \\ Expression 19 & \\ {Tm}_{R - req} = \frac{\{ ( {P}_{BATT} + {P}_{CAR} ) \text{/} 2 \} + {Kb}_{F} \cdot {T}_{F - req} + {Kb}_{R} \cdot {T}_{R - req}}{ω {m}_{R} + {Kb}_{R}} & ( 19 )\end{matrix}$$

Then, the individual braking torque calculation device 51b calculates the requested motor torque Tm_{R-req} of the rear wheels 10RL, 10RR from the expression 19, and finds the requested electric brake braking torque Tb_{R-req} of the rear wheels 10RL, 10RR, using the expression 12 as in Embodiment 1. On the other hand, the individual braking torque calculation device 51b sets the requested braking torque T_{F-req} of the front wheels 10FL, 10FR directly as a requested electric brake braking torque Tb_{F-req} of the front wheels 10FL, 10FR.

### Embodiment 3

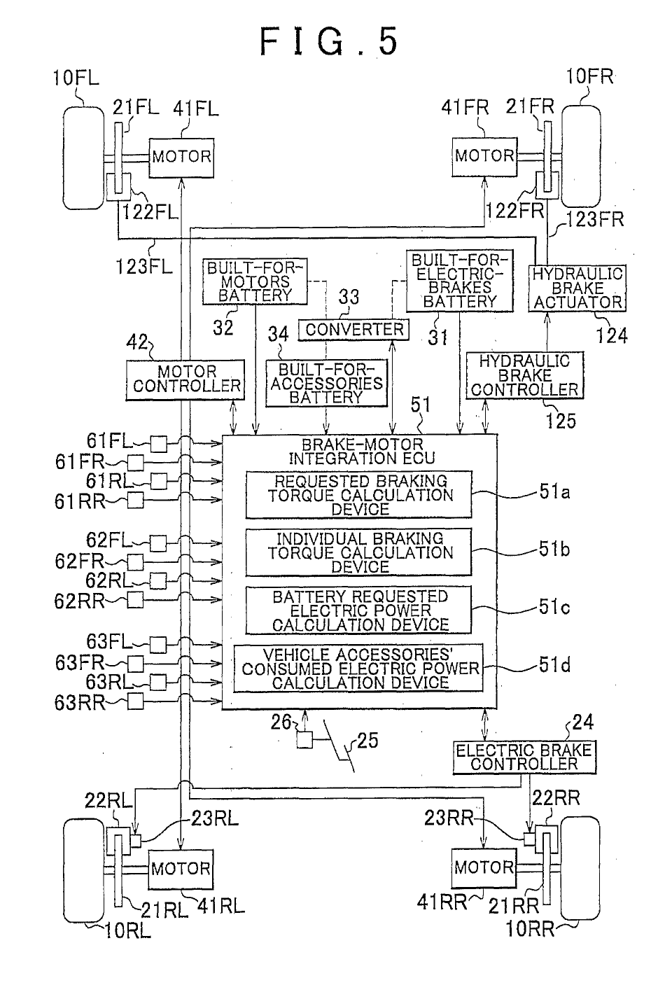

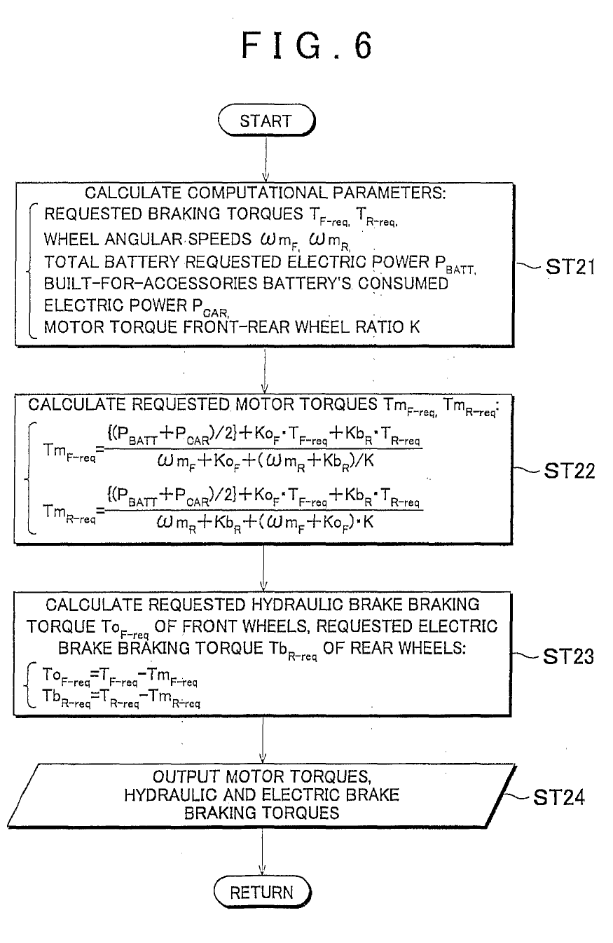

Next, Embodiment 3 of the braking force control device in accordance with the invention will be described with reference to FIGS. 5 and 6.

Embodiment 3 is about a braking force control device applicable to a vehicle as shown in FIG. 5 that is obtained by providing electric brakes only for the rear wheels 10RL, 10RR and providing hydraulic brakes that are hydraulically adjustable for the front wheels 10FL, 10FR in the vehicle of Embodiment 1. In the description below, the vehicle of Embodiment 3 is equipped with a built-for-accessories battery 34.

For example, the hydraulic brake device in Embodiment 3 includes disc rotors 21FL, 21FR for the front wheels 10FL, 10FR, calipers 122FL, 122FR provided with pistons (not shown) and brake pads (not shown) that generate mechanical braking torques To_{FL}, To_{FR} by pressing the disc rotors 21FL, 21FR, respectively, and also includes oil pressure pipings 123FL, 123FR that supply oil pressure for individually operating the pistons of the calipers 122FL, 122FR, and an oil pressure adjustment device (hereinafter, referred to as “electric hydraulic actuator”) 124 that adjusts separately the individual oil pressures of the oil pressure pipings 123FL, 123FR.

It is to be noted herein that the hydraulic brake device causes a hydraulic brake controller 125 as a hydraulic brake control device to control the operation of the electric hydraulic actuator 124, thereby causing desired hydraulic brake braking torques (hereinafter, referred to as “hydraulic brake braking torques”) To_{FL}, To_{FR} to be generated on the front wheels 10FL, 10FR. For example, the electric hydraulic actuator 124 in Embodiment 3 is provided with an oil reservoir, an oil pump, various valve devices such as a pressure increase/decrease control valve for increasing or decreasing the pressure in each of the oil pressure pipings 123FL, 123FR, etc. Then, in this electric hydraulic actuator 124, the pressure increase/decrease control valve is subjected to a duty-ratio control in accordance with a command from the hydraulic brake controller 125 if necessary, so that the oil pressure that acts on the piston of each of the calipers 122FL, 122FR is adjusted. In this description, the hydraulic brake braking torques To_{FL}, To_{FR} are defined as positive values.

The hydraulic brake controller 125 is an electronic control device (ECU) constructed of a CPU and the like, similarly to the brake controller 24 for the electric brake devices, and to the motor controller 42. Similarly to the brake controller 24 or the like, the hydraulic brake controller 125 operates the electric hydraulic actuator 124 upon receiving a command from the brake-motor integration ECU 51. Hence, the braking force control device of Embodiment 3 is constructed of the brake-motor integration ECU 51, the brake controller 24, the motor controller 42, and she hydraulic brake controller 125. Incidentally, in Embodiment 3, the brake controller 24 for the electric brake device will be termed “the electric brake controller 24”, in order to make clear the differences from the hydraulic brake controller 125.

Incidentally, the supply of electricity to the electric hydraulic actuator 124 may also be performed by preparing a hydraulic brake device-dedicated battery (built-for-hydraulic-brake battery), or may also be performed from existing batteries (the built-for-electric-brakes battery 31, the built-for-motors battery 32 and the built-for-accessories battery 34). In Embodiment 3, the supply of electricity is performed via the built-for-accessories battery 34.

Hereinafter, differences of the braking force control device of Embodiment 3 from the foregoing braking force control devices will be described in detail together with a computational processing operation in Embodiment 3 shown by the flowchart of FIG. 6. In the following description, in order to simplify the description as in Embodiment 1, it is assumed that equal hydraulic brake braking torques. To_{FL}, To_{FR} (=To_{F}) are caused to be generated on the front wheels 10FL, 10FR.

Firstly, the brake-motor integration ECU 51 in Embodiment 3 finds computational parameters for calculating the requested hydraulic brake braking torque To_{F-req} of the front wheels 10FL, 10FR, the requested electric brake braking torque Tb_{R-req} of the rear wheels 10RL, 10RR, and the requested motor torques Tm_{F-req}, Tm_{R-req} of all the wheels 10FL, 10FR, 10RL, 10RR (step ST21).

In this step, the brake-motor integration ECU 51 calculates the requested braking torque T_{F-req} of the front wheels 10FL, 10FR, the requested braking torque T_{R-req} of the rear wheels 10RL, 10RR, the wheel angular speed ωm_{F} of the front wheels 10FL, 10FR, the wheel angular speed ωm_{R} of the rear wheels 10RL, 10RR, the total battery requested electric power P_{BATT}, the built-for-accessories battery's consumed electric power P_{CAR}, and the motor torque front-rear wheel ratio K, similarly to Embodiment 1. In Embodiment 3, when the total battery requested electric power P_{BATT} and the built-for-accessories battery's consumed electric power P_{CAR} are to be found, the amount of electric power consumed to drive the electric hydraulic actuator 124 is also included in the target amount of electricity charged in the built-for-accessories battery 34.

Subsequently, the brake-motor integration ECU 51, using the individual braking torque calculation device 51b, calculates the requested motor torques Tm_{F-req}, Tm_{R-req} req of the front wheels 10FL, 10FR and the rear wheels 10RL, 10RR (step ST22).

In this step, the individual braking torque calculation device 51b uses a computational expression for the requested motor torque Tm_{F-req} of the front wheels 10FL, 10FR and a computational expression for the requested motor torque Tm_{R-req} of the rear wheels 10RL, 10RR shown below as expressions 23, 24 that are derived on the basis of a relational expression shown below as an expression 20 that concerns the electric power balance of the batteries (the built-for-electric-brakes battery 31, the built-for-motors battery 32 and the built-for-accessories battery 34) in the entire vehicle.

Expression 20

P_{BATT}=(Pm_{F}+Pm_{R}−Po_{F}−Pb_{R})·2−P_{CAR} (20)

In the expression 20, “Po_{F}” represents an electric power per front wheel that is needed to generate the requested hydraulic brake braking torque To_{F-req} on the front wheels 10FL, 10FR (hereinafter, referred to as “hydraulic brakes' consumed electric power”), and can be represented by the following expression 21 through the use of the hydraulic brake braking torque/electric power conversion coefficient Ko_{F} of the front wheels 10FL, 10FR and the requested hydraulic brake braking torque To_{F-req} of the front wheels 10FL, 10FR. The hydraulic brake braking torque/electric power conversion coefficient Ko_{F} is a characteristic value dependent on the hydraulic brake system that represents a relationship between the hydraulic brake braking torque To_{F} of the front wheels 10FL, 10FR and the magnitude of electric power needed to generate the hydraulic brake braking torque To_{F}, and represents a necessary electric power per unit torque. In this description, the hydraulic brakes' consumed electric power Po_{F} is defined as a positive value.

Expression 21

Po_{F}=Ko_{F}·To_{F-req}. (21)

When computational expressions for the requested motor torques Tm_{F-req}, Tm_{R-req} are to be derived, a braking torque relational expression regarding the front wheels 10FL, 10FR shown below as an expression 22 is used.

Expression 22

T_{F-req}=To_{F-req}+Tm_{F-req} (22)

$$\begin{matrix}Expression 23 & \\ {Tm}_{F - req} = \frac{\{ ( {P}_{BATT} + {P}_{CAR} ) \text{/} 2 \} + {Ko}_{F} \cdot {T}_{F - req} + {Kb}_{R} \cdot {T}_{R - req}}{ω {m}_{F} + {Ko}_{F} + ( ω {m}_{R} + {Kb}_{R} ) \text{/} K} & ( 23 ) \\ Expression 24 & \\ {Tm}_{R - req} = \frac{\{ ( {P}_{BATT} + {P}_{CAR} ) \text{/} 2 \} + {Ko}_{F} \cdot {T}_{F - req} + {Kb}_{R} \cdot {T}_{R - req}}{ω {m}_{R} + {Kb}_{R} + ( ω {m}_{F} + {Ko}_{F} ) \cdot K} & ( 24 )\end{matrix}$$

Then, the individual braking torque calculation device 51b calculates the requested hydraulic brake braking, torque To_{F-req} of the front wheels 10FL, 10FR and the requested electric brake braking torque Tb_{R-req} of the rear wheels 10RL, 10RR (step ST23). In Embodiment 3, the individual braking torque calculation device 51b finds the requested hydraulic brake braking torque To_{F-req} regarding the front wheels 10FL, 10FR by substituting in the expression 25 the requested braking torque T_{F-req} of the front wheels 10FL, 10FR found in step ST21 and the requested motor torque Tm_{F-req} of the front wheels 10FL, 10FR. On the other hand, the individual braking torque calculation device 51b finds the requested electric brake braking torque Tb_{R-req} of the rear wheels 10RL, 10RR by substituting the requested motor torque Tm_{R-req} and the requested braking torque T_{R-req} of the rear wheels 10RL, 10RR in the expression 12 as in Embodiment 1.

Expression 25

To_{F-req}=T_{F-req}−Tm_{F-req} (25)

After that, the brake-motor integration ECU 51 in Embodiment 3 sends commands to the motor controller 42, the brake controller 24 and the hydraulic brake controller 125 to cause the requested motor torques Tm_{F-req}, Tm_{R-req}, the requested electric brake braking torque To_{R-req} of the rear wheels 10RL, 10RR and the requested hydraulic brake braking torque To_{F-req} of the front wheels 10FL, 10FR found in steps ST22 and ST23 to be generated on the corresponding wheels 10FL, 10FR, 10RL, 10RR (step ST24).

Therefore, a difference or balance among the consumed electric power of the built-for-electric-brakes battery for the generation of the electric brake braking torque Tb_{R} of the rear wheels 10RL, 10RR, the regenerative electric power to the built-for-motors battery 32 caused by the generation of the motor torques Tm_{F}, Tm_{R} of all the wheels 10FL, 10FR, 10RL, 10RR, and the consumed electric power of the built-for-accessories battery 34 for the use of accessories and for the generation of the hydraulic brake braking torque To_{F} of the front wheels 10FL, 10FR constitutes the total battery requested electric power P_{BATT}. Therefore, Embodiment 3, similarly to Embodiment 1, is also able to generate the requested braking torques T_{F-req}, T_{R-req} based on the electric brake braking torque Tb_{R}, the motor torques Tm_{F}, Tm_{R}, and the hydraulic brake braking torque To_{F} while securing amounts of electricity charged in all the batteries of the vehicle (the built-for-electric-brakes battery 31, the built-for-motors battery 32 and the built-for-accessories battery 34). Hence, in Embodiment 3, it is possible to cause the requested braking torques T_{F-req}, T_{R-req} requested by the driver or the vehicle to be generated on the front wheels 10FL, 10FR and the rear wheels 10RL, 10RR while maintaining proper amounts of electricity stored in all the batteries of the vehicle. Therefore, the vehicle becomes able to obtain vehicle deceleration that is needed.

Thus, Embodiment 3, similarly to the Embodiment 1, is able to prevent declines in the electric brake braking torque Tb_{R} of the rear wheels 10RL, 10RR, the motor torques Tm_{F}, Tm_{R}, and the hydraulic brake braking torque To_{F} of the front wheels 10FL, 10FR associated with imbalanced charging/discharging, and is able to achieve substantially the same effects as Embodiment 1.

Although, in the foregoing description, Embodiment 3 is applied to a vehicle obtained by replacing the electric brakes the front wheels 10FL, 10FR with the hydraulic brakes in the vehicle of Embodiment 1, a braking force control device in accordance with the invention may also be applied to a vehicle obtained by replacing the electric brakes of the rear wheels 10RL, 10RR with hydraulic brakes in the vehicle of Embodiment 1, and this application achieves substantially the same effects as mentioned above.

In this case, a computational expression for the requested motor torque Tm_{F-req} of the front wheels 10FL, 10FR and a computational expression for the requested motor torque Tm_{R-req} of the rear wheels 10RL, 10RR shown below as expressions 29, 30 on the basis of a relational expression shown below as an expression 26 which concerns the electric power balance of the batteries (the built-for-electric-brakes battery 31, the built-for-motors battery 32 and the built-for-accessories battery 34) in the entire vehicle.

Expression 26

P_{BATT}=(Pm_{F}+Pm_{R}−Pb_{F}−Po_{R})·2 (b 26)

In the expression 26, “Po_{R}” represents a hydraulic brakes' consumed electric power per rear wheel that is needed in order to generate the requested hydraulic brake braking torque To_{F-req} on the rear wheels 10RL, 10RR, and can be expressed by an expression 27 similarly to the hydraulic brakes' consumed electric power Po_{F} of the front wheels 10FL, 10FR, by using the hydraulic brake braking torque/electric power conversion coefficient Ko_{R} of the rear wheels 10RL, 10RR and the requested hydraulic brake braking torque To_{R-req} of the rear wheels 10RL, 10RR. The hydraulic brake braking torque/electric power conversion coefficient Ko_{R} is a characteristic value dependent on the hydraulic brake system that represents a relationship between the hydraulic brake braking torque To_{R} of the rear wheels 10RL, 10RR and the magnitude of electric power needed in order to generate the hydraulic brake braking torque To_{R}, and represents a necessary electric power per unit torque. In this description, the hydraulic brakes' consumed electric power Po_{R} is also defined as a positive value.

Expression 27

Po_{R}=Ko_{R}·To_{R-req} (27)

Furthermore, when computational expressions for the requested motor torques Tm_{F-req}, Tm_{R-req} are to be derived, a braking torque relational expression regarding the rear wheels 10RL, 10RR shown below as an expression 28 is used.

Expression 28

T_{R-req}=To_{R-req}+Tm_{R-req} (28)

$$\begin{matrix}Expression 29 & \\ {Tm}_{F - req} = \frac{\{ ( {P}_{BATT} + {P}_{CAR} ) \text{/} 2 \} + {Kb}_{F} \cdot {T}_{F - req} + {Ko}_{R} \cdot {T}_{R - req}}{ω {m}_{F} + {Kb}_{F} + ( ω {m}_{R} + {Ko}_{R} ) \text{/} K} & ( 29 ) \\ Expression 30 & \\ {Tm}_{R - req} = \frac{\{ ( {P}_{BATT} + {P}_{CAR} ) \text{/} 2 \} + {Kb}_{F} \cdot {T}_{F - req} + {Ko}_{R} \cdot {T}_{R - req}}{ω {m}_{R} + {Ko}_{R} + ( ω {m}_{F} + {Kb}_{F} ) \cdot K} & ( 30 )\end{matrix}$$

In this case, the individual braking torque calculation device 51b calculates the requested motor torque Tm_{F-req} of the front wheels 10FL, 10FR from the expression 29, and finds the requested electric brake braking torque Tb_{F-req} of the front wheels 10FL, 10FR, using the expression 11 as in Embodiment 1. On the other hand, the individual braking torque calculation device 51b calculates the requested motor torque Tm_{R-req} of the rear wheels 10RL, 10RR from the expression 30, and finds the requested hydraulic brake braking torque To_{R-req} of the rear wheels 10RL, 10RR by substituting the requested motor torque Tm_{R-req} of the rear wheels 10RL, 10RR and the requested braking torque T_{R-req} of the rear wheels 10RL, 10RR in the following expression 31 that is an expression modified from the expression 28.

Expression 31

To_{R-req}=T_{R-req}−Tm_{R-req} b 31)

A braking force control device in accordance with the invention may also be applied to a vehicle in which hydraulic brake devices as in Embodiment 3 are provided for all the wheels 10FL, 10FR, 10RL, 10RR, and this application also achieves substantially the same effects as mentioned above.

### INDUSTRIAL APPLICABILITY

As described above, the braking force control device in accordance with invention is suitable to a technology that generates the requested braking torque on the wheels while optimizing the amounts of electricity stored in the batteries.

1: A braking force control device comprising:
a brake control device that controls a mechanical brake braking torque that is generated on a wheel by operating an electric actuator so as to achieve a brake braking torque requested;
a motor control device that controls a motor torque that is generated on the wheel by operating a motor so as to achieve the requested motor torque;
a requested braking torque calculation device that calculates a requested braking torque of the wheel requested by a driver or a vehicle;
a battery requested electric power calculation device that calculates a battery requested electric power based on a target amount of electricity charged in a battery mounted in the vehicle; and
an individual braking torque calculation device that calculates the requested motor torque and the brake braking torque requested that cause the requested braking torque to be generated based on the requested braking torque and the battery requested electric power.

2: The braking force control device according to claim 1, wherein the individual braking torque calculation device calculates the brake braking torque requested and the requested motor torque by further factoring in a consumed electric power of another electric appliance.

3: The braking force control device according to claim 2, wherein the another electric appliance is an accessory.

4: The braking force control device according to claim 2, wherein the battery requested electric power is obtained by adding an electric power that corresponds to the target amount of electricity charged in the battery used for the another electric appliance.

5: The braking force control device according to claim 1, wherein the brake control device is an electric brake control device that performs such a control that a mechanical electric brake braking torque generated directly by the electric actuator becomes equal to a requested electric brake braking torque.

6: The braking force control device according to claim 1, wherein the brake control device is a hydraulic brake control device that performs such a control that a hydraulic brake braking torque generated via an oil pressure adjusted by the electric actuator becomes equal to a requested hydraulic brake braking torque.

7: The braking force control device according to claim 1, wherein the individual braking torque calculation device calculates the brake braking torque requested and the requested motor torque based on an electric power needed in order to generate the requested braking torque.

8: The braking force control device according to claim 1, wherein the individual braking torque calculation device calculates the requested motor torque so that the battery requested electric power is generated, and calculates the brake braking torque requested by subtracting the requested motor torque from the requested braking torque.

9: The braking force control device according to claim 1, wherein the target amount of electricity charged is a difference between a remaining capacity of the battery and a predetermined amount of electricity charged, and the battery requested electric power is an electric power that corresponds to the target amount of electricity charged.

10: The braking force control device according to claim 1, wherein the requested braking torque calculation device calculates the requested braking torque of the vehicle based on a brake operation amount, a vehicle speed, and a longitudinal acceleration and a lateral acceleration of the vehicle.

11: A braking force control method comprising:
controlling a mechanical brake braking torque that is generated on a wheel by operating an electric actuator so as to achieve a brake braking torque requested;
controlling a motor torque that is generated on the wheel by operating a motor so as to achieve the requested motor torque;
calculating a requested braking torque of the wheel requested by a driver or a vehicle;
calculating a battery requested electric power based on a target amount of electricity charged in a battery mounted in the vehicle; and
calculating the requested motor torque and the brake braking torque requested that cause the requested braking torque to be generated based on the requested braking torque and the battery requested electric power.

12: The braking force control method according to claim 11, wherein the individual braking torque calculation device calculates the brake braking torque requested and the requested motor torque by further factoring in a consumed electric power of another electric appliance.

13: The braking force control method according to claim 12, wherein the another electric appliance is an accessory.

14: The braking force control method according to claim 12, wherein the battery requested electric power is obtained by adding an electric power that corresponds to the target amount of electricity charged in the battery used for the another electric appliance.

15: The braking force control method according to claim 11, wherein a mechanical electric brake braking torque generated directly by the electric actuator becomes equal to a requested electric brake braking torque.

16: The braking force control method according to claim 11, wherein a hydraulic brake braking torque generated via an oil pressure adjusted by the electric actuator becomes equal to a requested hydraulic brake braking torque.

17: The braking force control method according to claim 11, wherein the brake braking torque requested and the requested motor torque are calculated based on an electric power needed in order to generate the requested braking torque.

18: The braking force control method according to claim 11, wherein the requested motor torque is calculated so that the battery requested electric power is generated, and the brake braking torque requested is calculated by subtracting the requested motor torque from the requested braking torque.

19: The braking force control method according to claim 11, wherein the target amount of electricity charged is a difference between a remaining capacity of the battery and a predetermined amount of electricity charged, and the battery requested electric power is an electric power that corresponds to the target amount of electricity charged.

20: The braking force control method according to claim 11, wherein the requested braking torque of the vehicle is calculated based on a brake operation amount, a vehicle speed, and a longitudinal acceleration and a lateral acceleration of the vehicle.
